(19) United States
(12) Patent Application Publication
(10) Pub. No.: US 2015/0276398 A1
(43) Pub. Date: Oct. 1, 2015

(54) DISTANCE DETERMINING APPARATUS, IMAGING APPARATUS, DISTANCE DETERMINING METHOD, AND PARALLAX-AMOUNT DETERMINING APPARATUS

(71) Applicant: CANON KABUSHIKI KAISHA, Tokyo (JP)

(72) Inventor: Kiyokatsu Ikemoto, Yokohama-shi (JP)

(21) Appl. No.: 14/671,873

(22) Filed: Mar. 27, 2015

(30) Foreign Application Priority Data
Mar. 31, 2014 (JP) 2014-074578

(51) Int. Cl. G01C 3/08; H04N 5/217; H04N 5/232

(52) U.S. Cl. CPC G01C 3/085; H04N 5/232; H04N 5/217

(57) ABSTRACT

A distance determining apparatus includes a distance calculating unit and a signal processor. The distance calculating unit calculates a distance to an object on the basis of a first signal corresponding to a light flux that has passed through a first pupil region of an exit pupil of an imaging optical system and a second signal corresponding to a light flux that has passed through a second pupil region of the exit pupil of the imaging optical system. The second pupil region is different from the first pupil region. The signal processor filters either one signal by using a filter based on an optical transfer function corresponding to the first pupil region and an optical transfer function corresponding to the second pupil region. The either one signal is one of the first signal and the second signal.

### BACKGROUND OF THE INVENTION

1. Field of the Invention

The present invention relates to a distance determining apparatus, an imaging apparatus, a distance determining method, and a parallax-amount determining apparatus.

2. Description of the Related Art

Distance determining techniques (ranging) applicable to digital cameras are known. A ranging technique of determining a distance from an image sensor to an object scene includes using a phase difference detection method. In the phase difference method, some pixels in an imaging device have a function for achieving ranging. Each of such pixels includes multiple photoelectric conversion units which receive a light flux that has passed through respective different areas on a pupil of an imaging optical system. The amount of a shift between image signals generated by the photoelectric conversion units is estimated, and a defocus amount is calculated, whereby ranging is achieved by known methods.

When the photoelectric conversion units have pupil transmittance distributions different from each other, the image signals have values different from each other, resulting in reduction in accuracy in estimation of the amount of a shift between the image signals and reduction in accuracy in ranging. Japanese Patent No. 3240648 describes a method in which an image-signal correction filter is applied to both of a pair of image signals, whereby the values of image signal are corrected, resulting in improved accuracy in ranging.

In the case where an image-signal correction filter is applied to both of a pair of image signals, especially when a filter having a large number of taps (cells) is used, as in the case of contemporary image sensors, the processing time of the image-signal correction process is increased, and the ranging speed is decreased.

### SUMMARY OF THE INVENTION

The present invention provides a distance determining apparatus and a distance determining method which achieve fast and highly accurate ranging, or provides a parallax-amount determining apparatus which determines a parallax amount with high speed and high accuracy.

A distance determining apparatus according to the present invention includes a distance calculating unit and a signal processor. The distance calculating unit calculates a distance to an object on the basis of a first signal corresponding to a light flux that has passed through a first pupil region of an exit pupil of an imaging optical system and a second signal corresponding to a light flux that has passed through a second pupil region of the exit pupil of the imaging optical system. The second pupil region is different from the first pupil region. The signal processor filters either one signal by using a filter based on an optical transfer function corresponding to the first pupil region and an optical transfer function corresponding to the second pupil region. The either one signal is one of the first signal and the second signal.

A distance determining method according to the present invention includes calculating a distance to an object on the basis of a first signal corresponding to a light flux that has passed through a first pupil region of an exit pupil of an imaging optical system and a second signal corresponding to a light flux that has passed through a second pupil region of the exit pupil of the imaging optical system, the second pupil region being different from the first pupil region; and filtering either one signal by using a filter based on an optical transfer function corresponding to the first pupil region and an optical transfer function corresponding to the second pupil region. The either one signal is one of the first signal and the second signal.

A parallax-amount determining apparatus according to the present invention includes a signal processor and a parallax-amount calculating unit. The signal processor filters either one signal by using a filter. The either one signal is one of a first signal corresponding to a light flux that has passed through a first pupil region of an exit pupil of an imaging optical system and a second signal corresponding to a light flux that has passed through a second pupil region of the exit pupil of the imaging optical system. The second pupil region is different from the first pupil region. The filter is based on an optical transfer function corresponding to the first pupil region and an optical transfer function corresponding to the second pupil region. The parallax-amount calculating unit calculates a parallax amount corresponding to the amount of a shift between the either one signal having been filtered by the signal processor and a signal different from the either one signal among the first signal and the second signal.

Further features of the present invention will become apparent from the following description of exemplary embodiments with reference to the attached drawings.

### BRIEF DESCRIPTION OF THE DRAWINGS

FIG. 1A is a schematic diagram illustrating an exemplary imaging apparatus having a distance determining apparatus; FIG. 1B is a schematic diagram illustrating an exemplary imaging device; and FIG. 1C is a schematic sectional view illustrating an exemplary pixel, according to a first embodiment.

FIGS. 2A to 2C are diagrams for describing sensitivity characteristics and pupil regions of a ranging pixel.

FIGS. 3A and 3B are two-dimensional images illustrating point spread functions; and FIG. 3C is a Cartesian graph illustrating intensity values of the point spread functions.

FIGS. 4A and 4B are diagrams illustrating exemplary processes of a method of determining a distance, according to the first embodiment.

FIGS. 5A and 5B are diagrams illustrating a deformed point spread function obtained by correcting a signal, according to the first embodiment.

FIGS. 6A to 6D are diagrams for describing a ranging pixel disposed on the periphery of an imaging device and pupil regions of the ranging pixel, according to the first embodiment.

FIG. 7 is a diagram illustrating an exemplary process (algorithm) of a method of determining a distance, according to another embodiment.

### DESCRIPTION OF THE EMBODIMENTS

### First Embodiment

### Distance Determining Apparatus

Description is made below by using a digital still camera as an exemplary imaging apparatus provided with a distance determining apparatus according to the present invention. However, the application of the present invention is not limited to this. For example, the distance determining apparatus according to the present invention may be applied to a digital video camera, a digital distance gauge, or the like. In the description in which figures are referred to, even when the figure numbers are different, identical components are designated with identical reference numerals, and repeated description thereof is avoided as much as possible.

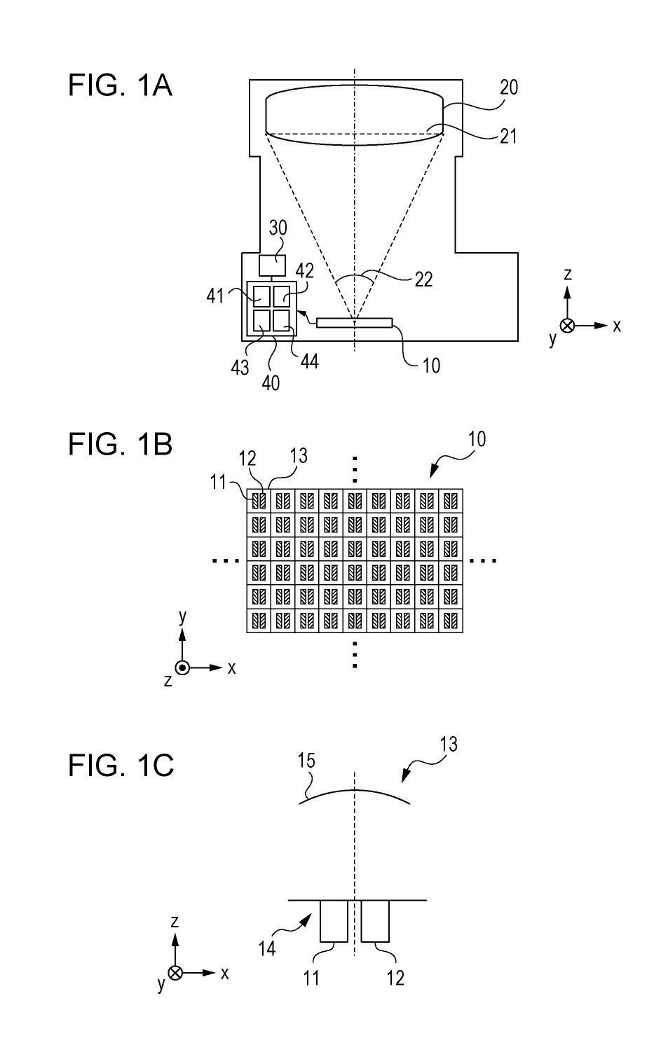

FIG. 1A is a schematic diagram illustrating an imaging apparatus (for example, a camera), which includes a distance determining apparatus 40 according to the first embodiment. The imaging apparatus also includes an imaging device 10 (image sensor), an imaging optical system 20 (lens system), and a recording device 30 (memory), as well as the distance determining apparatus 40. Further, the imaging apparatus includes, for example, a driving mechanism for ranging using the imaging optical system 20, a shutter, a unit for generating an image to be viewed (processor), and a display device such as a liquid-crystal display (LCD) for checking an image.

FIG. 1B is a schematic diagram illustrating an exemplary imaging device 10. The imaging device 10 includes multiple pixels 13 having photoelectric conversion units 11 and 12. Specifically, a solid-state imaging device, such as a complementary metal oxide semiconductor (CMOS) sensor (a sensor employing a complementary metal-oxide-semiconductor technology) or a charge-coupled device (CCD) sensor (a sensor employing charge-coupled devices), may be used as the imaging device 10.

FIG. 1C is a schematic sectional view illustrating an exemplary pixel 13. The photoelectric conversion units 11 and 12 in the pixel 13 are formed in a substrate 14. The pixel 13 is provided with a microlens 15.

As illustrated in FIGS. 1A to 1C, the imaging optical system 20 images an object (or scene) in the outside on the surface of the imaging device 10. The imaging device 10 obtains a light flux that has been transmitted through an exit pupil 21 of the imaging optical system 20, via the microlens 15 by using the photoelectric conversion unit 11 or the photoelectric conversion unit 12 of a pixel 13, and converts it into an electric signal. Specifically, a light flux that has passed through a first pupil region of the exit pupil 21 is converted into an electric signal by the photoelectric conversion unit 11 of each of the pixels 13. A light flux that has passed through a second pupil region of the exit pupil 21 which is different from the first pupil region is converted into an electric signal by the photoelectric conversion unit 12 of each of the pixels 13. The pixel 13 includes a floating diffusion (FD) portion, a gate electrode, and wiring in order to output the electric signals to the distance determining apparatus 40.

The distance determining apparatus 40 is constituted, for example, by a signal processing device having a central processing unit (CPU) and a memory. The CPU executes programs, whereby the function of the distance determining apparatus 40 is achieved. The signal processing device may be formed by using an integrated circuit in which semiconductor devices are integrated, and may be formed, for example, by using an integrated circuit (IC), a large-scale integrated circuit (LSI), a system LSI, a microprocessing unit (MPU), or a central processing unit (CPU).

The distance determining apparatus 40 includes a distance calculating unit 41 which calculates the distance to an object on the basis of a first signal corresponding to a light flux that has passed through the first pupil region of the exit pupil 21 of the imaging optical system 20 and a second signal corresponding to a light flux that has passed through the second pupil region. The first signal constitutes a group of electric signals generated by the photoelectric conversion units 11 of the pixels. In the first signal, the position of each of the pixels is associated with an electric signal generated by the photoelectric conversion unit 11 of the pixel. The second signal constitutes a group of electric signals generated by the photoelectric conversion units 12 of the pixels. In the second signal, the position of each of the pixels is associated with an electric signal generated by the photoelectric conversion unit 12 of the pixel. If a signal obtained after noise reduction and filtering are performed on the first signal corresponds to the light flux that has passed through the first pupil region of the exit pupil 21 of the imaging optical system 20, such a signal is encompassed in the first signal. The second signal is similarly defined.

The distance determining apparatus 40 includes a signal processor 42, a shift-amount calculating unit 43, and a filter generating unit 44 as well as the distance calculating unit 41. The signal processor 42 has a function of filtering either one of the first signal and the second signal by using a filter based on an optical transfer function corresponding to the first pupil region and an optical transfer function corresponding to the second pupil region. The shift-amount calculating unit 43 has a function of calculating the amount of a shift between the first signal and the second signal. The filter generating unit 44 has a function of generating a filter used in the filtering performed by the signal processor 42, on the basis of the shift amount calculated by the shift-amount calculating unit 43.

The recording device 30 has a function of recording a signal which has been read or a calculation result.

In the configuration having multiple photoelectric conversion units, such as that of a pixel 13, an image signal equivalent to that from a pixel having a single photoelectric conversion unit can be generated by summing signals obtained by the photoelectric conversion units 11 and 12, in the distance determining apparatus according to the present invention. The pixels 13 having such a configuration may be disposed at the positions of all of the pixels of the imaging device 10. Alternatively, the pixels 13 may be disposed at the positions of some of the pixels of the imaging device 10 so that a configuration including both of pixels having a single photoelectric conversion unit and the pixels 13 having multiple photoelectric conversion units is employed. In the latter configuration, the pixels 13 may be used to perform ranging, and the other pixels may obtain an image of an object. The pixels 13 may be discretely arranged in the imaging device 10, or may be disposed in such a manner that spacing between pixels 13 in the x direction is different from that in the y direction.

### Method of Determining Distance

In the present invention, the distance between the imaging optical system 20 and the imaging device 10 is long with respect to the size of a pixel 13. Thus, a light flux that has passed through a different position in the exit pupil 21 of the imaging optical system 20 enters the surface of the imaging device 10 with a different incident angle. The photoelectric conversion units 11 and 12 receive a light flux passing within a predetermined angle range 22 (see FIG. 1A) in accordance with the shape of the exit pupil 21 and the positions of the photoelectric conversion units 11 and 12 on the imaging device 10. A sensitivity distribution on the exit pupil which is obtained when sensitivity characteristics of the photoelectric conversion unit 11 or 12 with respect to an incident light flux are projected on the exit pupil in accordance with the angle is called a pupil transmittance distribution. The centroidal position of the pupil transmittance distribution is called a pupil centroid. The pupil centroid may be calculated by using Expression 1 described below. In Expression 1, r represents coordinates on the exit pupil 21, and t represents the pupil transmittance distribution of the photoelectric conversion unit 11 or 12. The integration is performed over the area of the exit pupil 21.

$$g = \frac{\int r \cdot t ( r ) d r}{\int t ( r ) d r} \qquad Expression 1$$

In the area through which a light flux received by a photoelectric conversion unit passes, an area of the exit pupil 21 which includes the pupil centroid and through which a light flux entering in an angle range in which the sensitivity of the photoelectric conversion unit is high passes is called a pupil region. The direction between the pupil centroids of the two pupil regions is called the pupil dividing direction. In the first embodiment, the pupil dividing direction is set to the x direction. The x direction is referred to as a first direction, and the y direction perpendicular to the x direction is referred to as a second direction.

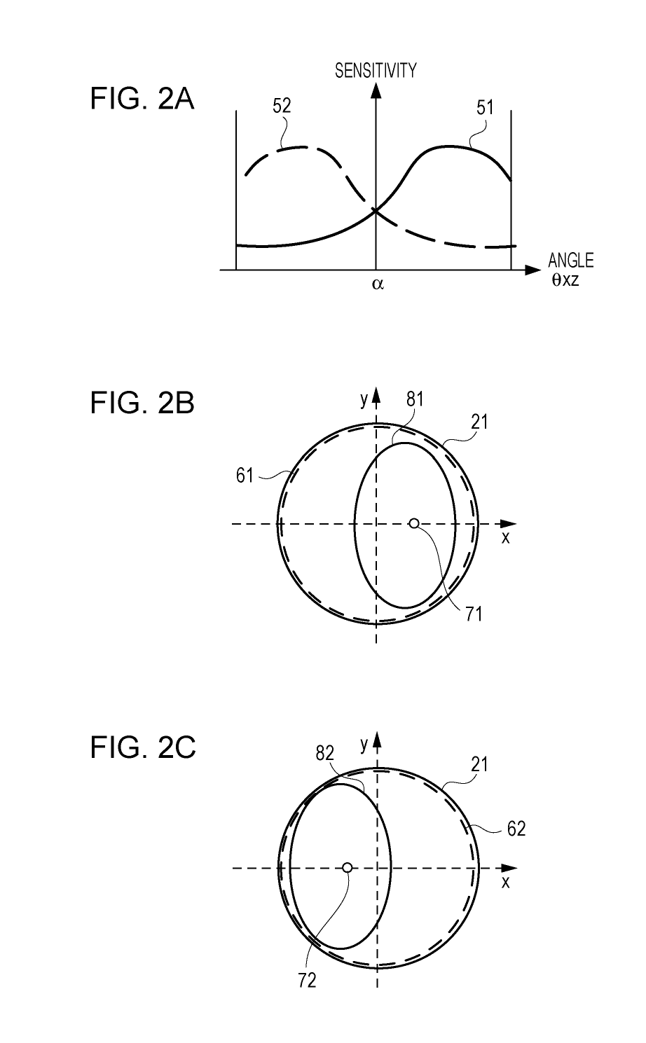

FIG. 2A illustrates a sensitivity characteristic 51 of the photoelectric conversion unit 11 and a sensitivity characteristic 52 of the photoelectric conversion unit 12 with respect to a light flux entering the xz plane. The horizontal axis represents an angle of the z axis with respect to a light flux entering the xz plane, and the vertical axis represents the sensitivity. The symbol α represents an incident angle of a principal ray entering a pixel. The incident angle is based on the direction (z direction) perpendicular to the in-plane direction of the imaging device. When the pixel 13 is located at the center of the imaging device 10, α is equal to zero. When the pixel 13 is located on the periphery, α is a value other than zero.

FIG. 2B is a diagram illustrating the exit pupil 21 of the imaging optical system 20, and a pupil transmittance distribution 61, a pupil centroid 71, and a pupil region 81 (first pupil region) which correspond to the photoelectric conversion unit 11. The pupil region 81 is a pupil region which is eccentric to the center of the exit pupil 21 in the +x direction (first direction). The photoelectric conversion unit 11 of each of the pixels 13 receives a light flux that has passed mainly through the pupil region 81. This configuration allows a first signal S₁ corresponding to a light flux that has passed through the pupil region 81 to be obtained.

FIG. 2C is a diagram illustrating the exit pupil 21 of the imaging optical system 20, and a pupil transmittance distribution 62, a pupil centroid 72, and a pupil region 82 (second pupil region) which correspond to the photoelectric conversion unit 12. The pupil region 82 is a pupil region which is eccentric to the center of the exit pupil 21 in the −x direction. The photoelectric conversion unit 12 of each of the pixels 13 receives a light flux that has passed mainly through the pupil region 82. This configuration allows a second signal S₂ corresponding to a light flux that has passed through the pupil region 82 to be obtained.

The signal S₁ (j=1 or 2) may be expressed by using Expression 2 described below.

$$\begin{matrix}{S}_{j} = f * {PSF}_{j} \\ = iFFT \{ Ff \cdot {OTF}_{j} \} \\ = iFFT \{ Ff \cdot {MTF}_{j} \cdot exp [ i {PTF}_{j} ] \}\end{matrix} \qquad Expression 2$$

The symbol f represents the light quantity distribution of an object image, and the symbol * represents convolution integration. The subscript j represents 1 or 2. The symbol PSFⱼ represents a transfer function indicating the degree of degradation produced by the imaging optical system 20 or the imaging device 10 when a light flux from an object is obtained as a signal Sⱼ, and is called a point spread function. The difference between the shape of PSF₁ and that of PSF₂ determines the difference between the shape of the signal S₁ and that of the signal S₂. The symbol F represents the Fourier transform, and the symbol Ff represents the result obtained by performing the Fourier transform on the light quantity distribution f of an object. The symbol iFFT represents the inverse Fourier transform.

The symbol OTFⱼ represents a transfer function obtained by performing the Fourier transform on the point spread function PSFⱼ, and is called an optical transfer function. The symbol OTFⱼ is expressed as a function which has a modulation transfer function MTFⱼ in an amplitude term and which has a phase transfer function PTFⱼ in a phase term in the spatial frequency domain. The functions MTFⱼ and PTFⱼ are functions of determining a change amount of the amplitude and the position, respectively, of each of the space frequency components involved in transmission. The functions OTFⱼ, MTFⱼ, and PTFⱼ are an optical transfer function corresponding to the jth pupil region, a modulation transfer function corresponding to the jth pupil region, and a phase transfer function corresponding to the jth pupil region. The symbol j represents 1 or 2.

The distance to an object is calculated from the amount of a shift between the signal S₁ and the signal S₂ in the x direction (first direction). This shift amount is obtained by using a known method. For example, the shift amount is obtained in such a manner that a correlation operation is performed while one of the pair of signals (S₁ and S₂) is shifted in the x direction, and that the shift amount is calculated when the correlation is the highest. A defocus amount is obtained from the obtained shift amount by using a known method, and the distance to an object is calculated.

Similarly to PSF, when MTF₁ and PTF₁ have a characteristic different from that of MTF₂ and that of PTF₂, respectively, the signal S₁ has a shape different from that of the signal S₂. The point spread function PSFⱼ is obtained depending on the signal Sⱼ, and is changed depending on optical characteristics (such as a focal length, an aperture, and a defocus amount) of the imaging optical system 20, the sensitivity characteristics of the pixels 13, the positions of the pixels 13 on the imaging device 10, and the like. The same is true for the functions OTFⱼ, MTFⱼ, and PTFⱼ.

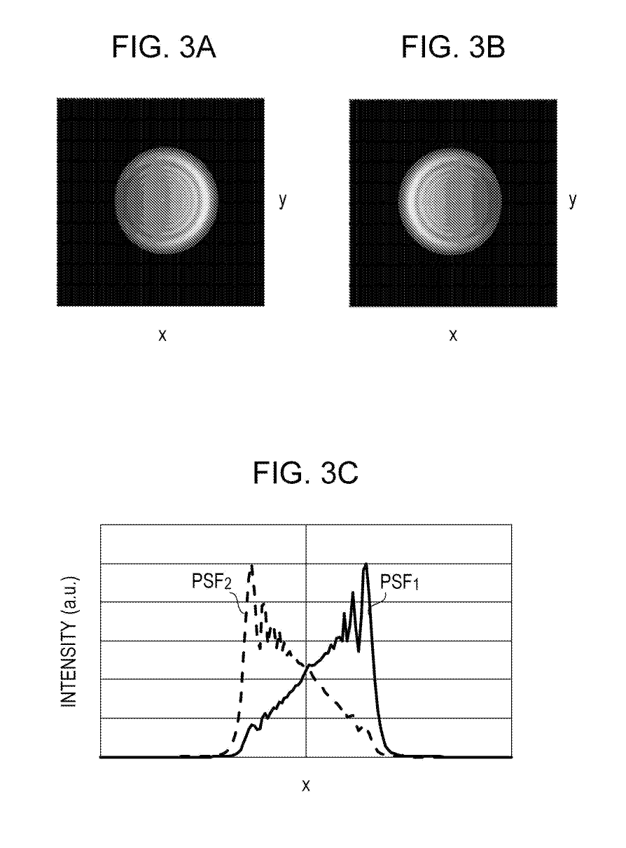

FIGS. 3A and 3B illustrate PSF₁ and PSF₂, respectively, and the vertical axis and the horizontal axis represent the x coordinate and the y coordinate, respectively. In FIGS. 3A and 3B, a larger value is represented by a whiter point. FIG. 3C is a sectional view of PSF₁ and PSF₂ in the x direction, where the solid line represents PSF₁ and the broken line represents PSF₂. Because of different vignetting in a light flux which is caused by a frame of the optical system and different angular dependence of sensitivity of the photoelectric conversion units 11 and 12, PSF₁ and PSF₂, MTF₁ and MTF₂, or PTF₁ and PTF₂ are functions having shapes different from each other. In this case, when the amount of a shift between the first signal S₁ and the second signal S₂ is calculated, an error likely occurs. Thus, accuracy in distance determination is decreased.

To prevent this, an image-signal correction filter is used to perform preprocessing for reducing an error in calculation of the shift amount. The present invention is related to the preprocessing, and is devised to reduce the processing time of the preprocessing. The preprocessing is described below on the basis of the method of determining a distance, according to the present invention.

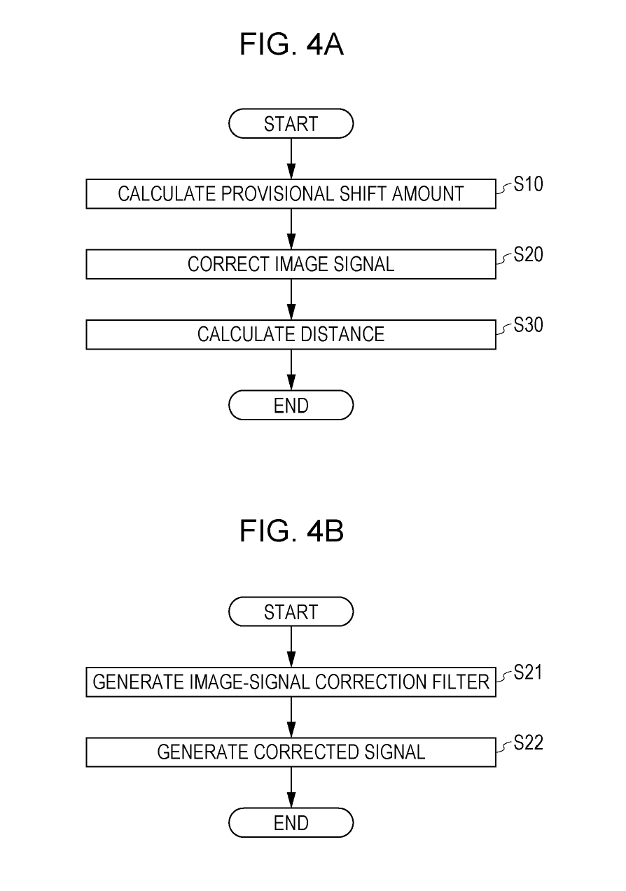

FIGS. 4A and 4B are flowcharts of the distance determining method of determining the distance to an object, which is performed by the distance determining apparatus 40. The distance determining method has a process of calculating a provisional shift amount, a process of correcting an image signal (signal processing process), and a process of calculating the distance. In the first embodiment, the preprocessing indicates the process of calculating a provisional shift amount and the process of correcting an image signal (signal processing process).

### Process of Calculating Provisional Shift Amount

As illustrated in FIG. 4A, the shift-amount calculating unit 43 calculates the amount of a provisional shift between the first signal S₁ and the second signal S₂ (step S10). The shift amount may be obtained by using the above-described known method.

### Process of Correcting Image Signal

As illustrated in FIG. 4A, the signal processor 42 then subjects only the first signal S₁ to the image-signal correction process (step S20). In step S20, a corrected signal CS₁ is generated. In the first embodiment, an example in which the first signal S₁ is subjected to the image-signal correction process is described. However, only the second signal S₂ may be subjected to the image-signal correction process.

As illustrated in FIG. 4B, the image-signal correction process S20 has a process of generating an image-signal correction filter (step S21) and a process of generating a corrected signal (step S22). In step S21, the filter generating unit 44 generates an image-signal correction filter on the basis of the provisional shift amount calculated in step S10. For example, filter data (cell values) corresponding to the magnitude of the provisional shift amount is stored in advance, and filter data corresponding to the magnitude of the provisional shift amount is read, whereby the image-signal correction filter is generated. Then, the signal processor 42 performs convolution integration on the image-signal correction filter generated in step S21 with respect to the first signal S₁, thereby generating the corrected signal CS₁.

The image-signal correction filter used in this process has the following characteristic. That is, the image-signal correction filter is a two-dimensional filter having cells, the number of which is Ax in the x direction and Ay in the y direction (Ax and Ay are integers equal to or more than two). In addition, the image-signal correction filter is generated on the basis of the optical transfer function OTFⱼ. More specifically, the image-signal correction filter is generated on the basis of the reciprocal of the optical transfer function OTFⱼ corresponding to the first pupil region and the optical transfer function OTF₂ corresponding to the second pupil region, and the image-signal correction filter ICF is expressed by using Expression 3 described below.

$$ICF = iFFT \{ \frac{{MTF}_{2} \cdot exp [ i ( {PTF}_{2} + {PG}_{2} ) ]}{{MTF}_{1} \cdot exp [ i ( {PTF}_{1} + {PG}_{1} ) ]} \} \qquad Expression 3$$

The symbol PG₁ is a phase term obtained by converting the shift amount involved in the defocusing of the centroidal position of PSF₁ into a phase amount with respect to each of the space frequencies, and the symbol PG₂ is a phase term obtained by converting the shift amount involved in the defocusing of the centroidal position of PSF₂ into a phase amount with respect to each of the space frequencies. The symbol ICF is expressed as a function in which the phase terms PG′ and PG₂ are added to the product of the reciprocal of OTF₁ and OTF₂ (OTF₂/OTF₁) in the frequency space. Expression 3 may be expressed as Expressions 4 to 7 described below.

ICF=iFFT{HM−exp[i HP]} Expression 4

HM=MTF₂/MTF₁ Expression 5

HP=PTF₂−PTF₁+PG Expression 6

PG=PG₂−PG₁ Expression 7

The symbols HM and HP are an amplitude term and a phase term, respectively, in the frequency space of ICF. The symbol PG is a phase adjustment term obtained by converting the distance between the centroidal positions of PSF₁ and PSF₂ in the real space into a phase amount with respect to each of the space frequencies in the frequency space. The symbol PG is added to prevent the image signal from being moved by the distance between the centroids due to the image-signal correction process. The symbol PG is a term having a certain value independent of space frequencies, in the real space, and a term which does not affect the shape of a signal. Expression 3 may be transformed into other expressions. Either of the transformation expressions may be included in the embodiment for the image-signal correction filter according to the present invention.

As described above, ICF is determined in accordance with the ranging conditions, such as the state (the focal length, an aperture, and the defocus amount) of the imaging optical system 20 and the positions of the pixels 13 on the imaging device 10. Filter data corresponding to each of the conditions is stored in advance, and the filter data is read in accordance with a condition, whereby ICF is obtained. In addition to the above-described manner, only filter data corresponding to a typical provisional shift amount may be stored, and interpolation may be performed on the filter data stored in advance, for a provisional shift amount other than the typical value, whereby a filter is generated. Instead, filter data may be approximated by using a function, and coefficients of the function may be stored. For example, cell values of a filter are approximated by using an n-order function (n is a positive integer) using a position in the filter as a variable, and the coefficients of the function are stored. Then, coefficients are read in accordance with the ranging condition, and a filter is generated. This method allows the amount of filter data which is to be stored to be reduced, and allows the recording capacity for storing the filter to be reduced.

The corrected signal CS₁ generated through the image-signal correction process is expressed by Expression 8 using Expressions 2 and 4 to 7.

CS₁=S₁*ICF=iFFT{Ff−MTF₂−exp[i(PTF₂+PG)]} Expression 8

As a result, the modulation transfer function corresponding to the corrected signal CS₁ is MTF₂, and the phase transfer function is a sum of PTF₂ and PG which does not affect the shape of the signal.

When a point spread function CPSF₁ obtained by transforming PSF₁ is used, the corrected signal CS₁ may be expressed by Expression 9. The shape of CPSF₁ determines the shape of the corrected signal CS₁.

CS₁=f*CPSF₁ Expression 9

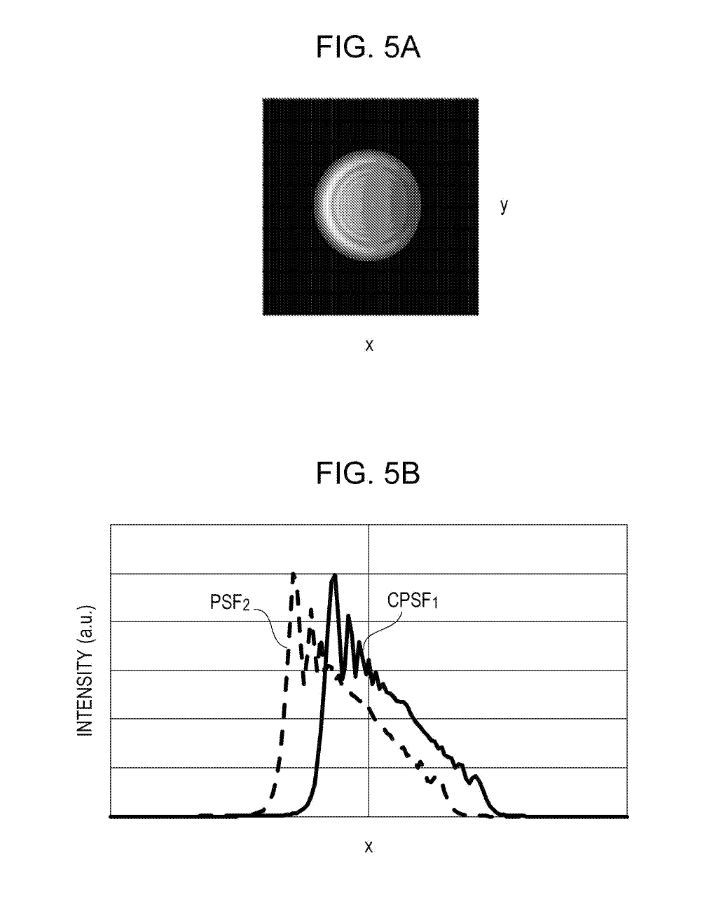

FIG. 5A illustrates CPSF₁, and the vertical axis and the horizontal axis represent the x coordinate and the y coordinate, respectively. Similarly to FIGS. 3A and 3B, a larger value is represented by a whiter point. FIG. 5B is a sectional view of CPSF₁ and PSF₂ in the x direction. The solid line represents CPSF₁, and the broken line represents PSF₂ (which is the same as the broken line in FIG. 3C). As can be seen from FIG. 5B, the corrected signal CS₁ and the second signal S₂ have shapes close to each other, and the shift amount may be calculated with high accuracy. Thus, the distance to an object may be calculated with high accuracy by using the process of calculating a distance, which is described below. When an expression obtained by substituting 2 into i in Expression 2 is compared with Expression 8, the corrected signal CS₁ is different from the second signal S₂ in that the phase adjustment term PG is present. Therefore, it is obvious that these signals have shapes close to each other.

By using the image-signal correction filter as described above, the image-signal correction process is performed on only one of the image signals (first signal S₁), whereby a corrected signal whose shape is close to that of the other image signal (second signal S₂) may be obtained. Therefore, the computation load in the image-signal correction process may be reduced, and high-speed preprocessing may be achieved.

### Process of Calculating Distance

As illustrated in FIG. 4A, the distance calculating unit 41 calculates the distance to an object from the amount of a shift between the corrected signal CS₁ and the second signal S₂ in the x direction (first direction) in step S30. The shift-amount calculating unit 43 calculates the shift amount which may be obtained by using the same method as that in the process of calculating a provisional shift amount (S10). For example, Expression 10 is used to obtain a defocus amount ΔL, and the distance to an object is calculated from the image formation relationship of the imaging optical system 20. The symbol d represents the shift amount; the symbol L, the distance between the exit pupil 21 and the imaging device 10; and the symbol w, the base length.

$$Δ L = \frac{dL}{w - d} \qquad Expression 10$$

Alternatively, a transformation coefficient for associating a shift amount d with a defocus amount ΔL may be calculated in advance, and the detected shift amount and the transformation coefficient are used to calculate the defocus amount ΔL. Instead, a transformation coefficient for associating a shift amount with the distance to an object may be used to directly calculate the distance to the object. An operation of calculating the base length depending on the photographing condition and the positions of the photoelectric conversion units on the imaging surface may be skipped, achieving high-speed calculation of a distance.

### Countermeasures Against Noise

In the image-signal correction process S20, a signal having better signal-to-noise (S/N) among the first signal S₁ and the second signal S₂ is desirably to be subjected to the image-signal correction process. Typically, a signal S contains noise. The noise occurs when, for example, light received by a photoelectric conversion unit is converted into an electric signal. The corrected signal CS₁ obtained in the case where the first signal S₁ contains noise δn may be expressed by Expression 11.

$$\begin{matrix}{CS}_{1} = iFFT \{ ( {FS}_{1} + δ n ) \cdot HM \cdot exp [ i HP ] \} \\ = iFFT \{ ( Ff \cdot {MTF}_{2} + δ n \cdot \frac{{MTF}_{2}}{{MTF}_{1}} ) \cdot exp [ i ( {PTF}_{2} + PG ) ] \}\end{matrix} \qquad Expression 11$$

The term, δn·MTF₂/MTF₁, is a term representing an adverse effect of noise on the corrected signal CS₁. The larger MTF₂/MTF₁ is, the larger the adverse effect of noise δn is. In particular, when MTF₂/MTF₁ is larger than 1, the noise is amplified, and the corrected signal CS₁ is markedly degraded. Therefore, a signal for correcting an image signal is desirably selected so that a larger one among MTF₁ and MTF₂ is used as a denominator. Comparison of MTFs is performed in such a manner that the amplitude terms MTF₁ and MTF₂ of the function obtained by performing the Fourier transform on PSFⱼ normalized with the sum of PSF₁ and PSF₂ are compared with each other. When MTF is large, a signal obtained by the photoelectric conversion units is increased, resulting in better S/N of the signal. Therefore, a signal having better S/N among the first signal S₁ and the second signal S₂ is selected, and the image-signal correction process is performed only on the selected signal, whereby the adverse effect of noise may be reduced.

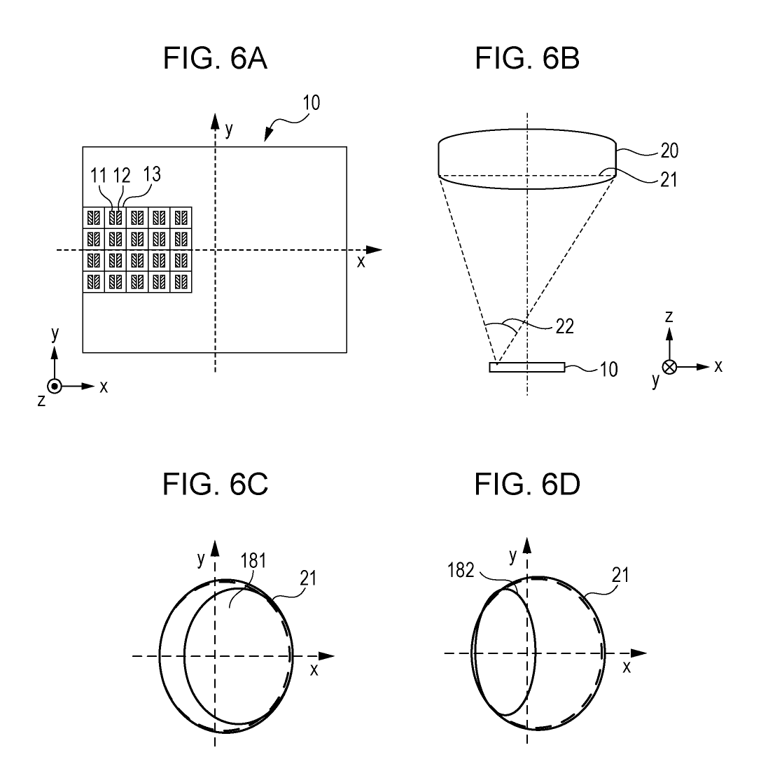

For example, as illustrated in FIG. 6A, among the photoelectric conversion units 11 and 12 included in a pixel 13 on the periphery of the imaging device 10, a signal obtained by the photoelectric conversion unit 11 which is located far from the center of the imaging device 10 is desirably subjected to the image-signal correction process. The reason is as follows. As illustrated in FIG. 6B, many oblique light beams (having an angle of +θxz) enter the pixel 13. As illustrated in FIGS. 6C and 6D, an adverse effect of vignetting caused by a frame of the imaging optical system 20 is increased, and the shape of the exit pupil 21 is deformed. The photoelectric conversion unit 11 receives a light flux that has passed through a wide pupil region 181 of the exit pupil 21, and the photoelectric conversion unit 12 receives a light flux that has passed through a narrow pupil region 182 of the exit pupil 21. Thus, in the pixel 13, a photoelectric conversion unit located farther from the center of the imaging device 10 has a wider pupil region, resulting in improved MTF and improved S/N of the signal. Therefore, among the first signal S₁ and the second signal S₂, a signal obtained by the photoelectric conversion unit 11 located far from the center of the imaging device 10 among the photoelectric conversion units 11 and 12 included in the pixel 13 is subjected to the image-signal correction process, whereby the adverse effect of noise may be reduced.

### Other Image-Signal Correction Filters

The image-signal correction filter ICF may be a filter having either one of the amplitude term HM and the phase term HP. That is, as in Expression 12 or 13, the image-signal correction filter ICF may use a filter for correcting only an amplitude or only a phase in the frequency space.

ICF=iFFT{HM} Expression 12

ICF=iFFT{exp[i HP]} Expression 13

Even when such a filter is used, either one of the modulation transfer function and the phase transfer function which form the first signal S₁ is made close to a corresponding one of the modulation transfer function and the phase transfer function which form the second signal S₂, whereby an error in the shift amount may be reduced. The filters expressed by Expressions 12 and 13 are filters based on the optical transfer function corresponding to the first pupil region and the optical transfer function corresponding to the second pupil region.

In the first embodiment, a method of generating a corrected signal by performing convolution integration on a filter with respect to a signal in the real space is described. Alternatively, the image-signal correction process may be performed in the frequency space. Filter data (data in the braces for the inverse Fourier transform iFFT in Expression 4) in the frequency space may be stored in advance. Then, the obtained signal S₁ is subjected to the Fourier transform, and a corrected signal FS₁ in the frequency space is generated. The corrected signal FS₁ is multiplied by a filter, and is subjected to the inverse Fourier transform, whereby the corrected signal CS₁ may be generated. When the filtering is performed, the computation load may be reduced compared with convolution integration, achieving fast and highly accurate ranging.

The transfer functions constituting the image-signal correction filter ICF are not limited to the above-described functions, and may be other functions approximate thereto. Functions approximate to the transfer functions by using a polynomial or the like may be used. The image-signal correction filter ICF generated by using these methods also achieves the effect of correcting an image signal as described above.

### Result of Ranging

The result of ranging performed by the distance determining apparatus according to the present invention may be used, for example, in focus detection in an imaging optical system. The distance determining apparatus according to the present invention achieves high-speed and highly accurate measurement of the distance to an object, and the amount of a shift between the object and the focal position of the imaging optical system may be found. The focal position of the imaging optical system is controlled, whereby the focal position may be adjusted to the object with high speed and high accuracy. An imaging apparatus, such as a digital still camera or a digital video camera, may be provided with the distance determining apparatus according to the first embodiment. On the basis of the distance determination result of the distance determining apparatus, focus detection in an optical system may be achieved. A distance map may be generated by using the distance determining apparatus according to the present invention.

### Second Embodiment

In a second embodiment, an image-signal correction filter different from that in the first embodiment is used. Other than the difference in image-signal correction filter, the second embodiment is the same as the first embodiment. Therefore, the image-signal correction filter used in the second embodiment is described below.

An image-signal correction filter ICF according to the second embodiment has an amplitude adjustment term MM which produces a smaller correction effect when MTF₁ is smaller, and which produces a larger correction effect when MTF₁ is larger. Specifically, the image-signal correction filter ICF may be expressed by Expressions 14 and 15.

$$\begin{matrix}ICF = iFFT \{ MM \cdot HM \cdot exp [ i HP ] \} & Expression 14 \\ MM = \frac{{MTF}_{1}^{2}}{{MTF}_{1}^{2} + K} & Expression 15\end{matrix}$$

The symbol K represents an adjustment factor, and is a positive real number. The magnitude of K enables the effect of correction of the amplitude and the phase of each of the space frequency components to be adjusted. When MTF₁ is small, MM is small. The image-signal correction filter ICF having such MM enables a space frequency component (a main component in the signal S₁) having large MTF₁ to obtain the effect of correcting an image signal, resulting in reduction in the adverse effect of noise in a space frequency component having small MTF₁.

The adjustment factor K may be changed in accordance with the S/N of the signal S₁. For example, in the image-signal correction process in step S20 in FIG. 4A, a process of adjusting the magnitude of the adjustment factor K on the basis of the S/N of the signal may be performed in the process S21 of generating an image-signal correction filter. When the S/N of the signal S₁ is good, the adjustment factor K is set to a small value (the minimum is 0). When the S/N is bad, the adjustment factor K is set to a large value. In accordance with the S/N of a signal, an adverse effect of noise may be adjusted, enabling correction of an image signal and ranging to be performed with higher accuracy. The image-signal correction process provided with these methods is performed, achieving reduction in an adverse effect of noise and fast and highly accurate ranging which is similar to that in the above description.

In the second embodiment, similarly to the first embodiment, the image-signal correction process may be performed in the frequency space, or the second signal S₂ may be subjected to the image-signal correction process. A signal having better S/N among the first signal S₁ and the second signal S₂ is desirably subjected to the image-signal correction process.

### Third Embodiment

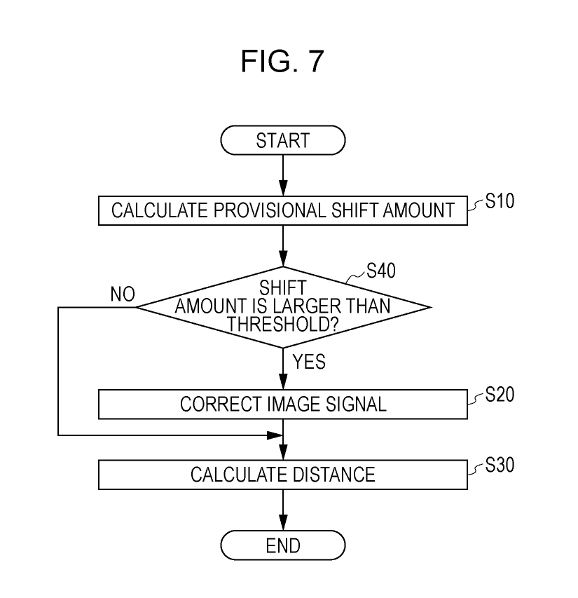

In a third embodiment, the distance determining apparatus according to the first embodiment further includes a determining unit (not illustrated) which determines whether or not the image-signal correction process is to be performed, on the basis of the magnitude of the shift amount calculated by the shift-amount calculating unit 43. FIG. 7 illustrates a distance determining method according to the third embodiment.

A larger defocus amount and a larger shift amount cause the difference between the shape of the first signal S₁ and that of the second signal S₂ to be larger. Therefore, a large shift amount produces a large detected error in the shift amount, resulting in degradation in accuracy in ranging. In contrast, a small shift amount produces a small detected error in the shift amount, allowing accuracy in ranging to be maintained. Therefore, as illustrated in FIG. 7, a determination process (step S40) of determining whether or not the magnitude of the amount of a provisional shift between the first signal S₁ and the second signal S₂ is larger than a threshold is provided after the process S10 of calculating a provisional shift amount.

If the shift amount is larger than the threshold, the image-signal correction process (S20) which is the same as that in the first embodiment is performed, and the distance calculation process (S30) is then performed. If the shift amount is equal to or smaller than the threshold, the image-signal correction process (S20) is not performed, and the distance calculation process (S30) is performed by using the provisional shift amount as the shift amount. In the determination process in step S40, the magnitude of the threshold may be determined by comparing a detected error of the shift amount with an allowable error of the shift amount. The allowable error of the shift amount is determined in accordance with the target accuracy in ranging and in accordance with the configuration and the use of the distance determining apparatus.

Provision of the determination process achieves adequate ranging according to an approximate distance to the object (defocus amount), and achieves faster and higher accurate ranging.

In the third embodiment, similarly to the first embodiment, the image-signal correction process may be performed in the frequency space, or the second signal S₂ may be subjected to the image-signal correction process. A signal having better S/N among the first signal S₁ and the second signal S₂ is desirably subjected to the image-signal correction process.

### Fourth Embodiment

In the above-described embodiments, the example in which the distance to an object is calculated is described. The present invention may be applied to a parallax-amount determining apparatus which determines the parallax amount corresponding to the shift amount. For example, in the parallax-amount determining apparatus, a process of extracting an object located at a position close to the in-focus position from an image may be performed on the basis of the shift amount. The parallax amount may be the amount of a shift between two signals, or may be a physical quantity related to these.

Instead of the distance calculating unit 41 of the distance determining apparatus 40 according to the first embodiment, the parallax-amount determining apparatus includes a parallax-amount calculating unit which calculates a parallax amount corresponding to the amount of a shift between two signals. The other configuration may be the same as that of the distance determining apparatus 40. Specifically, the two signals are a signal which is subjected to the image-signal correction process among the first signal and the second signal, and the other signal which is not subjected to the image-signal correction process among the first signal and the second signal. The parallax-amount determining apparatus may further include an extraction unit which extracts an object having a predetermined parallax amount from an image in accordance with the parallax amount (shift amount).

To achieve the method of determining a parallax amount according to the fourth embodiment, a process of calculating a parallax amount is performed instead of the distance calculating process S30 in the flowchart in FIG. 4A. The other processes may be the same as those in FIGS. 4A and 4B. In calculation of a parallax amount, Expression 10 may be used to calculate a defocus amount. Instead, the amount of a shift between signals may be calculated, or the physical quantity related to these may be calculated.

In the fourth embodiment, either one of the first signal and the second signal is also subjected to filtering using the image-signal correction filter, enabling a parallax amount to be determined with high speed and high accuracy.

Similarly to the distance determining apparatuses according to the first to third embodiments, the parallax-amount determining apparatus may be used as a part of the imaging apparatus.

In the fourth embodiment, similarly to the first embodiment, the image-signal correction process may be performed in the frequency space. A signal having better S/N among the first signal S₁ and the second signal S₂ is desirably subjected to the image-signal correction process.

### Other Embodiments

Certain aspects disclosed in the embodiments of the present invention can be realized by a computer, or one or more circuits (e.g., application specific integrated circuit (ASIC)), of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments. Specifically, a method or steps thereof may be performed by the computer of the system or apparatus by, for example, reading out and executing the computer executable instructions from the storage medium to perform the functions of one or more of the above-described embodiments and/or by controlling the one or more circuits to perform the functions of one or more of the above-described units. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-074578, filed Mar. 31, 2014, which is hereby incorporated by reference herein in its entirety.

What is claimed is:

1. A distance determining apparatus comprising:
a distance calculating unit that calculates a distance to an object on the basis of a first signal corresponding to a light flux which has passed through a first pupil region of an exit pupil of an imaging optical system and a second signal corresponding to a light flux which has passed through a second pupil region of the exit pupil of the imaging optical system, the second pupil region being different from the first pupil region; and
a signal processor that filters either one signal by using a filter based on an optical transfer function corresponding to the first pupil region and an optical transfer function corresponding to the second pupil region, the either one signal being one of the first signal and the second signal.

2. The distance determining apparatus according to claim 1,
wherein the either one signal is the first signal, and
wherein the filter is a filter based on a reciprocal of the optical transfer function corresponding to the first pupil region and the optical transfer function corresponding to the second pupil region.

3. The distance determining apparatus according to claim 2,
wherein the filter is expressed by a function having an amplitude term and a phase term in a frequency space, and
wherein the phase term of the filter includes a function expressing a difference between a phase transfer function corresponding to the second pupil region and a phase transfer function corresponding to the first pupil region.

4. The distance determining apparatus according to claim 3,
wherein the phase term of the filter includes a term for adjusting a phase.

5. The distance determining apparatus according to claim 4,
wherein the either one signal is the first signal, and
wherein the phase term of the filter includes a function expressed by the following expression,
PTF₂−PTF₁+PG
where PTF₁ represents the phase transfer function corresponding to the first pupil region, PTF₂ represents the phase transfer function corresponding to the second pupil region, and PG represents the phase adjustment term which has a certain value independent of a space frequency in a real space.

6. The distance determining apparatus according to claim 1,
wherein the filter is expressed by a function having an amplitude term and a phase term in a frequency space, and
wherein the amplitude term of the filter includes a function expressing a ratio between a modulation transfer function corresponding to the first pupil region and a modulation transfer function corresponding to the second pupil region.

7. The distance determining apparatus according to claim 6,
wherein the either one signal is the first signal, and
wherein the amplitude term of the filter includes a function of dividing the modulation transfer function corresponding to the second pupil region by the modulation transfer function corresponding to the first pupil region.

8. The distance determining apparatus according to claim 7,
wherein the modulation transfer function corresponding to the first pupil region is larger than the modulation transfer function corresponding to the second pupil region.

9. The distance determining apparatus according to claim 7,
wherein the first signal has S/N better than S/N of the second signal.

10. The distance determining apparatus according to claim 7,
wherein the amplitude term of the filter has a function expressed by the following expression,
$$\frac{{MTF}_{2}}{{MTF}_{1}} \cdot \frac{{MTF}_{1}^{2}}{{MTF}_{1}^{2} + K}$$
where MTF₁ represents the modulation transfer function corresponding to the first pupil region, MTF₂ represents the modulation transfer function corresponding to the second pupil region, and K is an adjustment factor and a positive real number.

11. The distance determining apparatus according to claim 10,
wherein, the better the S/N of the first signal is, the smaller the adjustment factor is.

12. The distance determining apparatus according to claim 1, further comprising:
a shift-amount calculating unit that calculates a shift amount on the basis of the first signal and the second signal.

13. The distance determining apparatus according to claim 12,
wherein, when the shift amount is larger than a threshold, the signal processor filters either one of the first signal and the second signal.

14. The distance determining apparatus according to claim 12, further comprising:
a filter generating unit that generates the filter on the basis of the shift amount.

15. An imaging apparatus comprising:
the distance determining apparatus according to claim 1;
an imaging optical system having the first pupil region and the second pupil region; and
an imaging device that obtains the first signal and the second signal.

16. The imaging apparatus according to claim 15,
wherein the imaging device includes a plurality of pixels,
wherein at least one pixel among the plurality of pixels includes a first photoelectric conversion unit that generates the first signal and a second photoelectric conversion unit that generates the second signal, and
wherein the signal processor uses the filter to filter a signal generated by a photoelectric conversion unit disposed farther from the center of the imaging device among the first photoelectric conversion unit and the second photoelectric conversion unit.

17. A parallax-amount determining apparatus comprising:
a signal processor that filters either one signal by using a filter, the either one signal being one of a first signal corresponding to a light flux which has passed through a first pupil region of an exit pupil of an imaging optical system and a second signal corresponding to a light flux which has passed through a second pupil region of the exit pupil of the imaging optical system, the second pupil region being different from the first pupil region, the filter being based on an optical transfer function corresponding to the first pupil region and an optical transfer function corresponding to the second pupil region; and
a parallax-amount calculating unit that calculates a parallax amount corresponding to the amount of a shift between the either one signal having been filtered by the signal processor and a signal different from the either one signal among the first signal and the second signal.

18. An imaging apparatus comprising:
the parallax-amount determining apparatus according to claim 17;
an imaging optical system having the first pupil region and the second pupil region; and
an imaging device that obtains the first signal and the second signal.

19. A distance determining method comprising:
calculating a distance to an object on the basis of a first signal corresponding to a light flux which has passed through a first pupil region of an exit pupil of an imaging optical system and a second signal corresponding to a light flux which has passed through a second pupil region of the exit pupil of the imaging optical system, the second pupil region being different from the first pupil region; and
filtering either one signal by using a filter based on an optical transfer function corresponding to the first pupil region and an optical transfer function corresponding to the second pupil region, the either one signal being one of the first signal and the second signal.
